(19) United States
(12) Patent Application Publication
(10) Pub. No.: US 2022/0309366 A1
(43) Pub. Date: Sep. 29, 2022

(54) SYSTEM APPARATUS AND METHOD OF CLASSIFYING BIO-MECHANIC ACTIVITY

(71) Applicant: New Stream Ltd., Kfar Sava (IL)

(72) Inventors: Gad Yehoshua Blumrozen, Tel Aviv (IL); Andrey Kolpakov, Skogås (SE); Boris Tyomkin, Kfar Sava (IL)

(21) Appl. No.: 17/321,532

(22) Filed: May 17, 2021

Related U.S. Application Data
(60) Provisional application No. 63/166,103, filed on Mar. 25, 2021.

(51) Int. Cl. G06N 5/04; G06N 20/00

(52) U.S. Cl. CPC G06N 5/04; G06N 20/00

(57) ABSTRACT

A system, device, and a method for monitoring bio-mechanic activity based on a training plan for a subject of interest (SoI) using an artificial intelligence (AI) model and the historical performance of other Sols of the same field of training as the SoI. The monitoring is done on the performance of the SoI and on achieving the goals set by the training plan. Feedback is provided based on the performance.

This application claims the benefit of priority to U.S. Provisional Patent Application Ser. No. 63/166,103, filed Mar. 25, 2021, entitled “SYSTEM APPARATUS AND METHOD OF CLASSIFYING BIO-MECHANIC ACTIVITY,” each of which is incorporated herein by reference in its entirety.

### TECHNICAL FIELD

Some embodiments described herein generally relayed to classifying a bio-mechanic activity.

### BACKGROUND

Wellbeing physical activity takes an important role in daily life for all populations and all ages. In many cases, while doing physical activity, a person that does the physical activity may use additional objects to interact with.

There is a plurality of systems processing methods used to train persons with their physical activity. However, those systems are not global for all types of trainees and may include a predetermined set of workouts and movements.

### BRIEF DESCRIPTION OF THE DRAWING

FIG. 1 illustrates a block diagram of a system for monitoring a bio-mechanic activity of a human, according to some demonstrative embodiments.

FIG. 2 illustrates a block diagram of apparatus for monitoring a bio-mechanic activity of a human, according to some demonstrative embodiments.

FIG. 3 illustrates a flow chart of a method for monitoring a bio-mechanic activity of a human, according to some demonstrative embodiments.

FIG. 4 illustrates a flow chart of a method for determining an SoI performance score, according to some demonstrative embodiments.

FIG. 5 illustrates a flow chart of a machine learning method for learning bio-mechanic activity of an SoI, according to some demonstrative embodiments.

FIG. 6 includes images 6a, 6b, 6c, and 6d that demonstrate a subject of interest, and an interacting object, and non-interacting objects at different scenes, according to some demonstrative embodiments.

FIG. 7 includes an image that demonstrates SoI skeleton points of measurements and an image that demonstrates a basketball player interacting with a ball, according to some demonstrative embodiments.

FIG. 8 illustrates a flow chart of a method of recognition of bio-mechanic activity primitives, according to some demonstrative embodiments.

FIG. 9 includes images that demonstrate skeleton features and performance scores, according to some demonstrative embodiments.

FIG. 10 includes images 10a, 10b, 10c, and 10d that demonstrate machine-learning-based feedback to a trainee, according to some demonstrative embodiments.

FIG. 11 illustrates a product of manufacture, according to some demonstrative embodiments.

### DETAILED DESCRIPTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units, and/or circuits have not been described in detail so as not to obscure the discussion.

Discussions made herein utilizing terms such as, for example, “processing,” “computing,” “calculating,” “determining,” “establishing,” “analyzing,” “checking,” or the like, may refer to operation(s) and/or process(es) of a computer, a computing platform, a computing system, or other electronic computing devices, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality,” as used herein, include, for example, “multiple” or “two or more.” For example, “a plurality of items” includes two or more items.

References to “one embodiment,” “an embodiment,” “demonstrative embodiment,” “various embodiments,” etc., indicate that the embodiment(s) so described may include a particular feature, structure, or characteristic, but not every embodiment necessarily includes the particular feature, structure, or characteristic. Further, repeated use of the phrase “in one embodiment” does not necessarily refer to the same embodiment, although it may.

As used herein, unless otherwise specified, the use of the ordinal adjectives “first,” “second,” “third,” etc., to describe a common object merely indicate that different instances of like objects are being referred to, and are not intended to imply that the objects so described must be in a given sequence, either temporally, spatially, in ranking, or any other manner.

As used herein, the term “circuitry” may refer to, be part of, or include, an Application Specific Integrated Circuit (ASIC), an integrated circuit, an electronic circuit, a processor (shared, dedicated, or group), and/or memory (shared, dedicated, or group), that execute one or more software or firmware programs, a combinational logic circuit, and/or other suitable hardware components that provide the described functionality. In some demonstrative embodiments, the circuitry may be implemented in, or functions associated with the circuitry may be implemented by one or more software or firmware modules. In some demonstrative embodiments, the circuitry may include logic, at least partially operable in hardware.

The term “logic” may refer, for example, to computing logic embedded in the circuitry of a computing apparatus and/or computing logic stored in a memory of a computing apparatus. For example, the logic may be accessible by a processor of the computing apparatus to execute the computing logic to perform computing functions and/or operations. In one example, logic may be embedded in various types of memory and/or firmware, e.g., silicon blocks of various chips and/or processors. Logic may be included in and/or implemented as part of various circuitry, e.g., radio circuitry, receiver circuitry, control circuitry, transmitter circuitry, transceiver circuitry, processor circuitry, and/or the like. In one example, logic may be embedded in volatile memory and/or non-volatile memory, including random access memory, read-only memory, programmable memory, magnetic memory, flash memory, persistent memory, and the like. Logic may be executed by one or more processors using memory, e.g., registers, stuck, buffers, and/or the like, coupled to the one or more processors, e.g., as necessary to execute the logic.

The term “module,” as used hereinbelow is an object file that contains code to extend the running kernel environment.

As used herein, the term “Artificial intelligence (AI)” is intelligence demonstrated by machines, unlike the natural intelligence displayed by humans and animals, which involves consciousness and emotionality. The term “artificial intelligence” is used to describe machines (or computers) that mimic “cognitive” functions that humans associate with the human mind, such as, for example, “learning” and “problem-solving.”

The term “machine learning (ML)” as used hereinbelow is a study of computer algorithms configured to improve automatically based on a received. ML is a subset of artificial intelligence. Machine learning algorithms build a mathematical model based on sample data, known as “training data,” to make predictions or decisions without being explicitly programmed to do so.

As used herein, the term “deep learning,” as used hereinbelow, is a class of machine learning algorithms that uses multiple layers to extract higher-level features from the raw input progressively. For example, in image processing, lower layers may identify edges, while higher layers may identify the concepts relevant to a human, such as, for example, digits or letters and/or faces.

The term “Artificial neural networks (ANNs), and/or neural networks (NNs), are computing systems vaguely inspired by the biological neural networks that constitute animal brains.

For example, an ANN is based on a collection of connected units or nodes called artificial neurons, which loosely model the neurons in a biological brain. An artificial neuron that receives a signal may process it and may signal neurons connected to it. For example, the “signal” at a connection is a real number, and the output of each neuron is computed by some non-linear functions of the sum of its inputs. The connections are called edges. Neurons and edges may have a weight that adjusts as learning proceeds. The weight increases or decreases the strength of the signal at a connection. Neurons may have a threshold such that a signal is sent only if the aggregate signal crosses that threshold. The neurons may be aggregated into layers. Different layers may perform different transformations on their inputs.

In some demonstrative embodiments, ways to use non-wearable sensing technologies (like video) to monitor, analyze a subject and its relationship with the interacting object, e.g., ball, and provide feedback to a user. For example, the feedback may be based on artificial intelligence (AI) trained on expert knowledge, analytical models, and success with the targets of the interacting objects, e.g., scoring a goal.

Some demonstrative embodiments may include a system and method for monitoring, analyzing, and providing feedback on performance with a score of human activity. For example, the score may be based on prior expert knowledge and/or on machine learning knowledge.

For example, the system may monitor and analyze, in real-time or in offline, activity parameters of subjects of interest, e.g., basketball players, related objects that the subject of interest may interact with, e.g., basketball, and the environment and/or a scene, e.g., a basketball court.

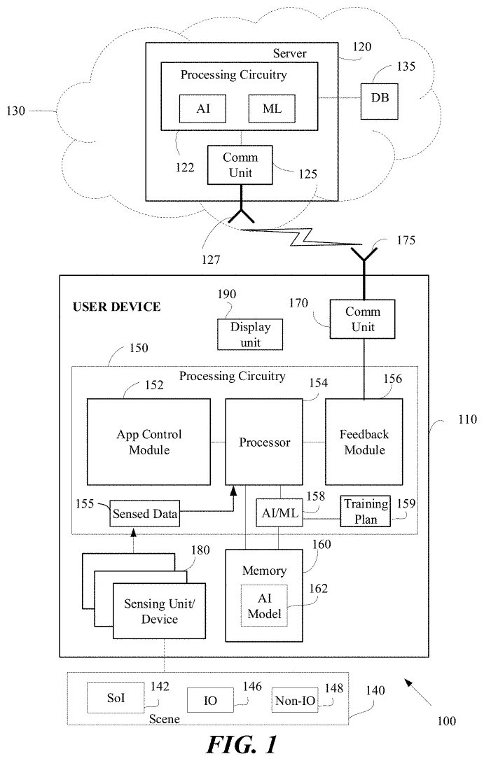

Turning first to FIG. 1, which is an illustration of block diagrams of a system to provide physical training, according to some demonstrative embodiments.

In some demonstrative embodiments of FIG. 1, system 100 may include a user device 110. For example, the user device 110 may be configured to monitor a bio-mechanic activity of a subject of interest (SoI), e.g., a human, analyzing the bio-mechanic activity and providing feedback on performance and a score based on prior expert knowledge and/or machine learning-based.

In some demonstrative embodiments, user device 110 may include a cellphone, a tablet, a laptop, a mobile device, personal assistance, etc.

In some demonstrative embodiments, user device 110 may include processing circuitry 150. Processing circuitry 150 may be configured to detect in sensed data at least one of a bio-mechanic activity of the SoI component, one or more interacting object (IO) with the SoI, and a scene based on machine learning trained data and a user preference for the SoI.

For example, the SoI component may include a skeleton posture of a human, the IO may include a basketball, a golf club, a weight, a football, and the like, and the scene may be a golf court, a gym, a basketball court, a football and/or soccer playfield and the like.

It should be understood that other SoI, 10, and scene may be used with some embodiments of this disclosure.

In some demonstrative embodiments, processing circuitry 150 may be configured to extract from the SoI component one or more measurements and provide one or more related to the time and space of one or more features.

In some demonstrative embodiments, processing circuitry 150 may be configured to extract from the IO one or more measures and provide one or more measurements related to the time and space of one or more features.

In some demonstrative embodiments, processing circuitry 150 may be configured to designate the activity type, analyze the bio-mechanic activity and compute a performance score using artificial intelligence and based on the machine learning trained data; and to generate performance feedback.

In some demonstrative embodiments, processing circuitry 150 may include an application control module 152 configured to interact with a user and for entering, for example, a training schedule for a trainee, if desired

In some demonstrative embodiments, processing circuitry 150 may include a processor 154 configured to execute one or more algorithms.

In some demonstrative embodiments, processing circuitry 150 may include a feedback module 156 configured to provide feedback on the trainee performance, for example, color feedback.

In some demonstrative embodiments, processing circuitry 150 may include an AI/ML module 158 configured to process AI algorithms and/or to do ML. For example, the AI/ML module 158 may do the ML when the user device 110 is offline.

In some demonstrative embodiments, user device 110 may include a memory 160 configured to store a sports training application.

In some demonstrative embodiments, user device 110 may include one or more sensing units 180, such as, for example, and a video camera configured to monitor the bio-mechanic activity of the trainee.

In some demonstrative embodiments, user device 110 may include a communication unit 170 configured to communicate with cloud 130 via one or more antennas 175, if desired. For example, the communication unit 170 may include a cellular radio, a wireless local area network (WLAN) radio, a wireless wide area network radio, and the like.

In some demonstrative embodiment, the one or more antennas 175 may include a dipole antenna, internal antenna, a cellular antenna, antenna array, and the like.

In some demonstrative embodiments, system 100 may include a server 120 operably coupled to a database (DB) 135 and a communication unit 125.

In some demonstration embodiments, server 120 may include a processor circuitry 122 configured to process AI algorithms and to do machine learning based on data stored at DB 125.

In some demonstrative embodiments, the communication unit 125 may be configured to communicate with user device 110 via one or more antennas 127, if desired. For example, the communication unit 125 may include a cellular radio, a wireless local area network (WLAN) radio, a wireless wide area network radio, and the like.

In some demonstrative embodiment, the one or more antennas 127 may include a dipole antenna, internal antenna, a cellular antenna, antenna array, and the like.

In some demonstrative embodiments, system 100 for monitoring bio-mechanic activity may include the user device 110. User device 110 may include the processing circuitry 150 and one or more sensors, e.g., sensing unit 180.

In some demonstrative embodiments, processing circuitry 150 may be configured to generate a training plan 159 for SoI 142 based on AI model 162 and historical performances of other Sols of the same field of training as the SoI.

In some demonstrative embodiments, processing circuitry 150 may be configured to set one or more goals to the SoI according to the training plan 159.

In some demonstrative embodiments, processing circuitry 150 may be configured to monitor by one or more sensors 180 the SoI performances toward the one or more goals according to the training plan 159.

In some demonstrative embodiments, processing circuitry 150 may be configured to extract from monitored data at least one of: one or more features of the SoI, one or more features of interacting objects (IO)s 146, one or more features of non-interacting objects 148, and provide one or more measurement results related to time and space of the one or more SoI features.

In some demonstrative embodiments, processing circuitry 150 may be configured to update the AI model 159 based on SoI performance data and machine learning data 158.

In some demonstrative embodiments, processing circuitry 150 may be configured to detect in sensed data received from the one or more sensors 180, first data related to the SoI 142, second data related to the one or more interacting Ios 146, third data related to the non-interacting object 148 and fourth data related to a scene 140.

For example, the detection may be done based on at least one method of one or more AI methods and trained data generated by a machine learning process. Although it should be understood that the detection may be done by using non-AI/machine learning methods.

In some demonstrative embodiments, processing circuitry 150 may be configured to extract from the first data the one or more features of the SoI 142 and may provide the one or more measurement results which related to time and space of the one or more SoI features, for example, to a display unit 190 and/or a file (not shown).

In some demonstrative embodiments, processing circuitry 150 may be configured to extract from the second data the one or more features of the IOs 146 and provide one or measurements results related to time and space of the one or more IO features, for example, to display unit 190 and/or a file (not shown).

In some demonstrative embodiments, processing circuitry 150, based on the machine learning trained data, may be configured to generate an activity type for the SoI 142, analyze the first data for bio-mechanic activity, and compute a performance score of the SoI 142 by using the at least one method of the one or more AI methods.

In some demonstrative embodiments, processing circuitry 150 may be configured to provide a performance feedback, for example, by using the feedback module on the SoI performance by using one or more types of the performance feedback.

In some demonstrative embodiments, the one or more sensors 180 may include one or more cameras and may be configured to monitor an interaction of the SoI 142 with the one or more IOs 146 in scene 140.

In some demonstrative embodiments, for example, the first data may include bio-mechanic activity data.

For example, in some demonstrative embodiments, machine learning may be configured to train data by comparing performance data of one or more players with the SoI performance based on machine learning trained data.

For example, in some demonstrative embodiments, the processing circuitry 150 may be configured to train data based on one or more analytical models.

For example, in some demonstrative embodiments, machine learning may be configured to train data based on one or more trainer preferences.

For example, in some demonstrative embodiments, the one or more features of the SoI may include at least one of a skeleton posture, one or more body-related features, and the like. For example, the one or more body-related features may include at least one of a distance between legs, a velocity of body parts, and an angle between the body parts and the like.

For example, the one or more features of the IOs may include an at least one of: a size of an IO, a velocity of the IO, an orientation of the IO, and a location in the space of the IO and the like.

In some demonstrative embodiments, the processing circuitry 150 may be configured to extract from the first data and the second data one or more features of interacting between the SoI and the IO.

For example, the one or more interacting features between the SoI and the IO may include at least one of a frequency of repetitive action, a location, one or more estimated forces, and one or more angles of the IO in relation to the SoI or the like.

In some demonstrative embodiments, the at least one of the AI methods may be configured to recognize an action. For example, the action may be a predefined activity of the SoI, which includes a goal-oriented, a start time, and an end time and the like.

For example, the action may be classified according to the one or more features, and the one or more features may include a list of primitive actions.

In some demonstrative embodiments, the SoI performance score may be determined based on one or more categories. For example, the one or more categories may include a reference book, a reference couch, a player model, and a success level of achieving a goal.

In some demonstrative embodiments, the reference book may be generated based on human analytical models and, the AI method may be configured to utilize known criteria to provide the performance score.

In some demonstrative embodiments, the reference couch may be generated based on an expert labeling by a human expert feedback. For example, the labeling may include a preferred skeleton angle when shooting to the basket, feedback provided by the manual user intervention, and by one or more abstract instructions or the like.

For example, the human expert feedback from a specific expert may be used to generate a unique expert model by using, for example, the AI model.

For example, in some demonstrative embodiments, the player model may be generated based on a similarity score of a player to another player. For example, AI inputs may analyze data related to at least one of a plurality of players, a plurality of top-ranked players, a specific player, and configured to provide a player score related to similarity the player model.

In some demonstrative embodiments, a success level of achieving a goal may be based on the success of achieving directed goals, and the AI may calculate the player score.

For example, in some demonstrative embodiments, the performance feedback may be provided whether the user device is offline or online and may include a real-time feedback based on the monitoring of the SoI and evaluation of the SoI performance.

For example, the performance feedback may include an at least one of: a visual color of reference feedback, a voice instruction feedback, and an electrical stimulation feedback.

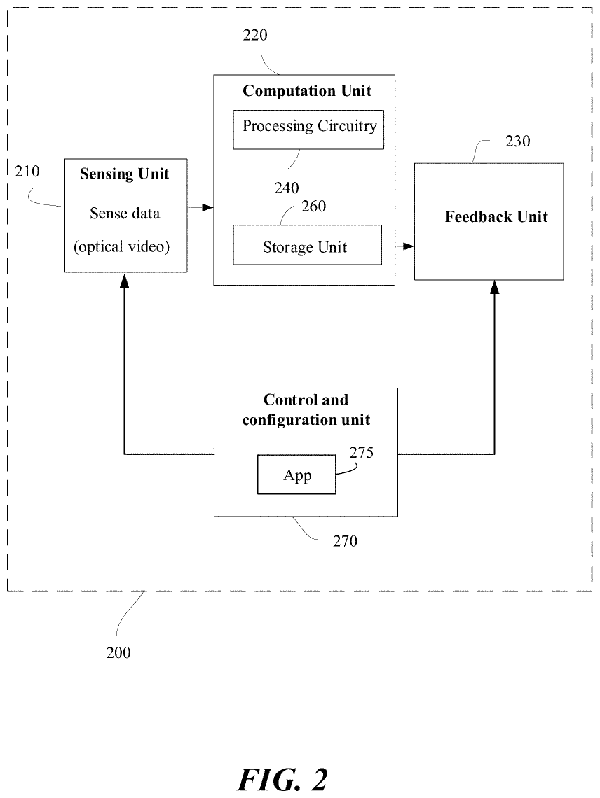

Reference is now made to FIG. 2, which is an illustration of a block diagram of an apparatus 200 for monitoring a bio-mechanic activity of a human, according to some demonstrative embodiments. For example, apparatus 200 may include a mobile device, a smartphone, a tablet, a laptop computer, a smart camera, augmented reality (AR) glasses, and the like.

In some demonstrative embodiments, apparatus 200 may include a sensing unit 210, a computation unit 220, a feedback unit 230, and control and a configuration unit 270.

In some demonstrative embodiments, sensing unit 210 may include a non-wearable video camera that may be based on one or more optical sensing nodes and/or on depth sensing. For example, the depth-sensing may be done by radar, LIDAR technologies, and the like.

In some demonstrative embodiments, sensing unit 210 may be configured to provide different sensing data, e.g., sensors attached to a body of an SoI, e.g., a trainee. The sensing unit 210 may be used to assist in the classification of the SoI performance Sensing unit 220 may be connected to a mobile device, e.g., the smartphone, one or more cameras to enhance the performance monitoring.

In some other embodiments, sensing unit 210 may be the one or more mobile device, e.g., cameras and sensors, if desired.

In some demonstrative embodiments, the computation unit 220 may include a processing circuitry 240 and storage unit 260. The computation unit 220 may be configured to process the sampled data and/or the sensed data, e.g., the data that have been generated by the sensing unit 210.

In some other demonstrative embodiments, the computation unit 220 may be configured to process the sampled data and/or the sensed data at the edge unit, e.g., mobile device, and/or at the cloud, e.g., a server if desired.

In some demonstrative embodiments, the computation unit 220 may include a storage unit 260, which may be configured to store the user data preferences, input, and the trained data results, if desired.

In some demonstrative embodiments, the feedback unit 230 may be configured to provide vocal and/or visual feedback to the user. For example, the vocal feedback may include audio feedback, such as, for example, real-time commands to improve the action of the SoI, e.g., trainee, player, etc., and/or any other sound.

In some demonstrative embodiments, the visual feedback may be displayed on the video clip of the SoI and may show, for example, a preferred skeleton angle of the SoI with actual and desired movements, different colors on the video based on the SoI, e.g., a trainee, a player, performance during the training, numeric comparison reports, etc.

In some demonstrative embodiments, the control configuration unit 270 may include a software application 275, e.g., App, and may be configured to enable the user to tag videos, define performance score types and thresholds. For example, the user may control the system operation and the algorithm preferences by using a touch screen, voice commands, typing text, and the like.

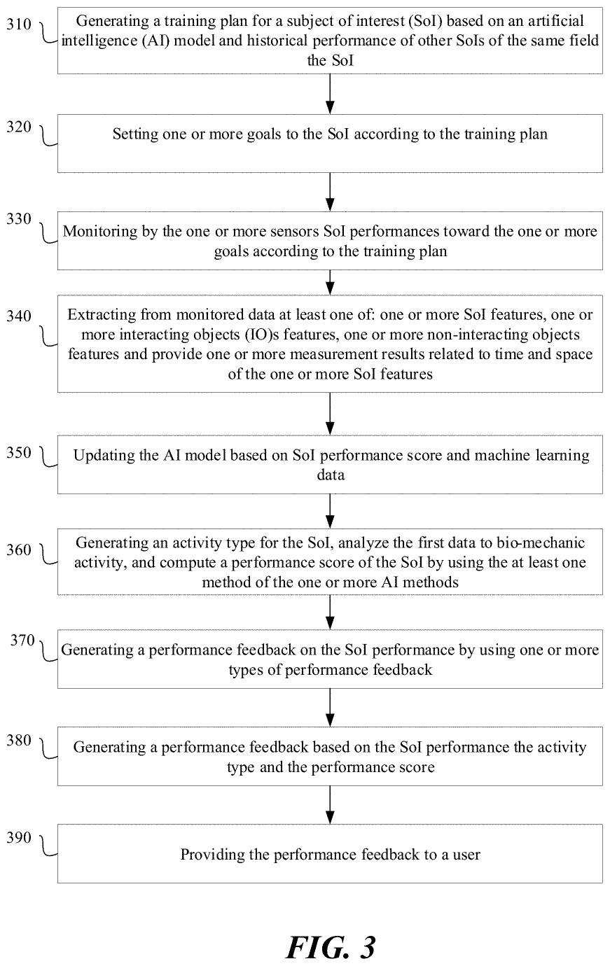

Reference is now made to FIG. 3, which is an illustration of a flow chart of a method 300 of monitoring a bio-mechanic activity of a human, according to some demonstrative embodiments.

In some demonstrative embodiments, method 300 for monitoring bio-mechanic activity by processing circuitry, e.g., processing circuitry 150 (FIG. 1), of a user device, e.g., user device 100 (FIG. 1), which may include one or more sensors, e.g., the sensor unit 180 (FIG. 1), may be configured to generate a training plan for a subject SoI based on an AI model and historical performance of other Sols of the same field the SoI (text box 310).

In some demonstrative embodiments, method 300 may set one or more goals to the SoI according to the training plan (text box 320) and monitor, by the one or more sensors, the SoI performances toward the one or more goals according to the training plan (text box 330).

In some demonstrative embodiments, method 300 may be configured to extract from monitored data at least one of one or more SoI features, one or more interacting objects (IO)s features, one or more non-interacting objects features and provide one or more measurement results related to time and space of the one or more SoI features (text box 340) and updating the AI model based on SoI performance score and machine learning data (text box 350).

For example, method 300 may be configured to detect in the sensed data received from the one or more sensors, e.g., the sensor unit 180 (FIG. 1), first data related to the SoI, second data related to the one or more interacting IOs, third data related to the non-interacting object, and fourth data related to a scene, for example, the detection may be done based on at least one method of one or more AI methods and trained data generated by a machine learning process.

For example, method 300 may be configured to extract from the first data one or more SoI features and provide one or more measurement results related to time and space of the one or more SoI features, extract from the second data one or more IO features and provide one or measurements results related to time and space of the one or more IO features.

In some demonstrative embodiment, method 300 may be configured to generate an activity type for the SoI, analyze the first data to bio-mechanic activity, and compute a performance score of the SoI by using the at least one method of the one or more AI methods based on the machine learning trained data (text box 370). Method 300 may be configured to generate performance feedback based on the SoI performance, the activity type and the performance score (text box 380).

In some detonative embodiment, method 300 may be configured to provide the performance feedback to a user (text box 390).

For example, the machine learning may generate training data by comparing performance data of one or more players with the SoI performance based on machine learning trained data, if desired.

For example, the machine learning may generate the training data based on one or more analytical models.

For Example, the machine learning may generate training data based on one or more trainer preferences.

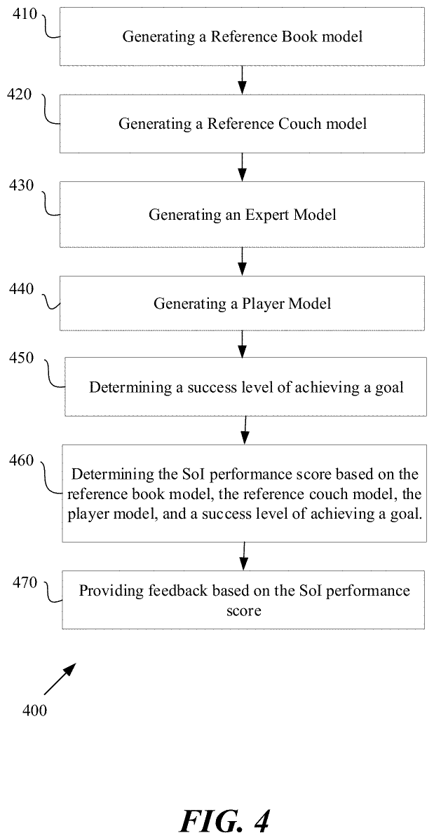

Reference is now made to FIG. 4, which is an illustration of a flow chart of a method 400 of determining an SoI performance score, according to some demonstrative embodiments.

In some demonstrative embodiments, method 400 may be configured to determine the SoI performance score based on one or more categories (text box 410). For example, the one or more categories may include a reference book, a reference couch, a player model, and a success level of achieving a goal.

In some demonstrative embodiments, method 400 may be configured to generate the reference book model based on human analytical models (text box 410). For example, the reference book may be used by the AI method, and the AI method may be configured to utilize known criteria to provide the performance score of SoI, e.g., player, trainee, or the like.

In some demonstrative embodiments, method 400 may be configured to generate the reference couch model based on expert labeling by a human expert feedback (text box 420). For example, the expert labeling may include a preferred skeleton angle when the SoI, e.g., the player, is shooting to the basket. The feedback for the SoI actions may be provided by the manual user intervention and by one or more abstract instructions.

In some demonstrative embodiments, method 400 may be configured to generate using the AI model, an expert model, e.g., a unique expert model, based on the human expert feedback from a specific expert (text box 430).

In some demonstrative embodiments, method 400 may be configured to generate the player model based on a similarity of a score of a player to another player (text box 440). For example, the AI may analyze scores of at least one of a plurality of players, a plurality of top-ranked players, a specific player, and may be configured to provide a score related to the similarity to the player model.

In some demonstrative embodiments, method 400 may be configured to determine the SoI performance score based on one or more categories, for example, the one or more categories may include a reference book, a reference couch, a player model, and a success level of achieving a goal (text box 460).

In some demonstrative embodiments, method 400 may be configured to provide at least one offline feedback or a real-time feedback based on the monitoring of the SoI and evaluation of the SoI performance (text box 470). For example, the feedback may include an at least one of visual colors, voice instructions, an electrical stimulation feedback, or the like.

Although that the description above the mothed is done in a sequential manner, it should be understood that in other embodiments, the method may be configured to perform the blooks of Fighter 4, e.g., text blooks 410-470, in parallel.

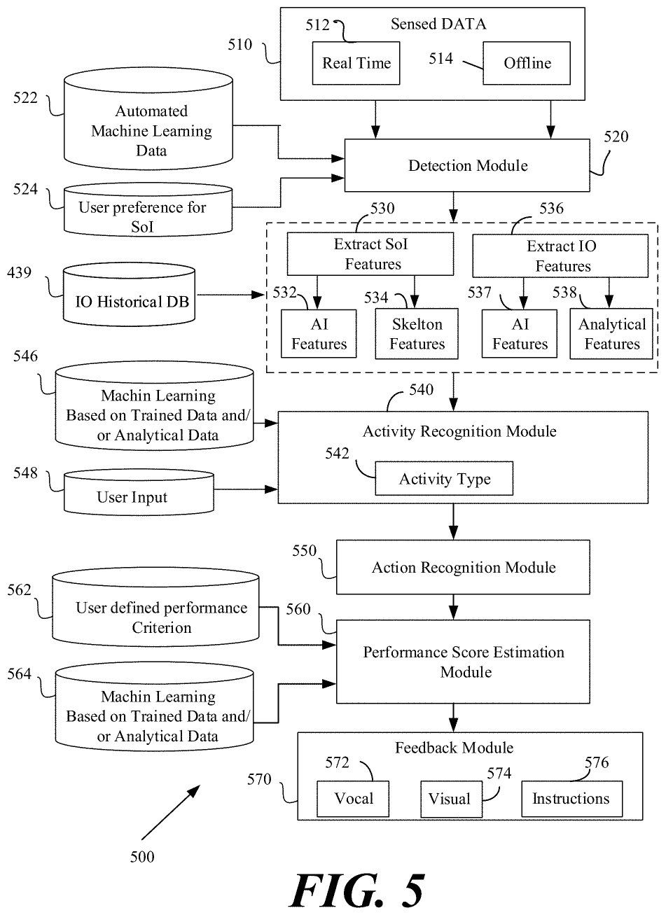

Reference is now made to FIG. 5, which is an illustration of a flow chart of a method 500 for learning bio-mechanic activity of an SoI, according to some demonstrative embodiments.

In some demonstrative embodiments, method 500 may be configured to process sensed data 510 in real-time 512 and/or when the user device and/or the edge device are offline 514. For example, the sensed data 510 may include a video clip of a player's performance, e.g., a basketball player, while training.

In some demonstrative embodiments, method 500 may have four stages. The first stage may include receiving a sensed data 510, e.g., video, and detection by a detection module 520 the SoI and the IO, based on user preference for the SOI 524 and/or an automated machine learning data 522. For example, the automated machine learning data 522 may be received from a machine learning training database.

In some demonstrative embodiments, the second stage may include extracting one or more features of the SoI 530 and OI 536 in the scene based on an IO historical database 439. For example, the IO historical database 439 may include features of basketball, golf club, golf ball, weights, and any other interacting objects.

For example, the extracted features of the SoI may include an AI features 532 and a Skelton features 532.

For example, the extracted features of the IO may include an AI features 537 and an analytical feature 538.

In some demonstrative embodiments, the third stage may use machine learning data based on trained data and/or Analytical data algorithms 546 and a user input 548 to generate an activity type 542 by an activity recognition module 542.

In some demonstrative embodiments, an action recognition module 550 may detect the action n performed by the SoI, and a performance score estimation module 560 may provide a score based on a user-defined performance criterion 562 and machine learning data based on trained data and/or Analytical data algorithms 564.

In some demonstrative embodiments, the fourth stage is providing a feedback to the user, for example, by a feedback module 570, based on the score. For example, the feedback may include a vocal feedback 572, a visual feedback 574, e.g., a color indication, instructions 576, and the like.

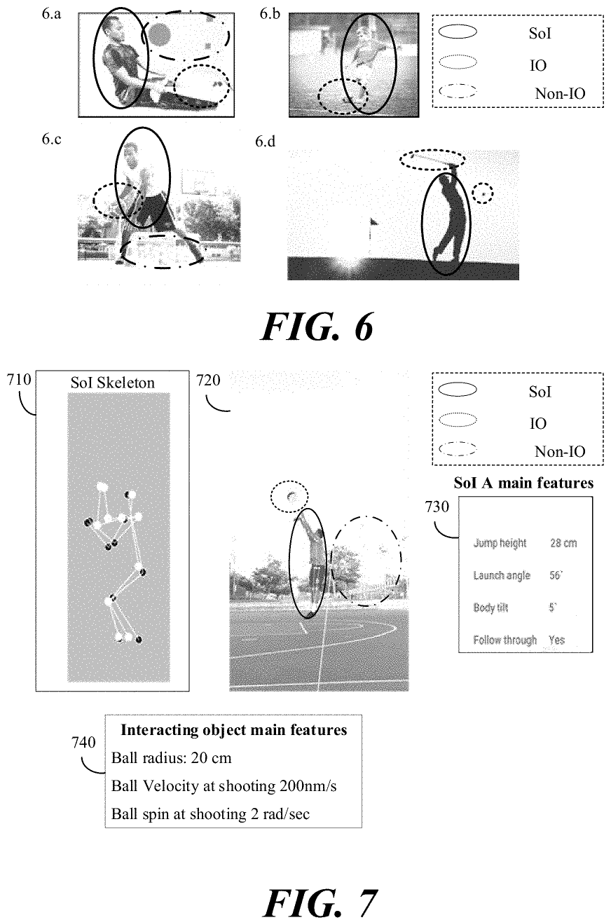

Reference is now made to FIG. 6, which includes images 6a, 6b, 6c, and 6d that demonstrate a subject of interest, and an interacting object, and a non-interacting object at different scenes, according to some demonstrative embodiments.

The example images of FIG. 6 may describe different case studies to evaluate the physical activity performance of the SoI, e.g., a player, a trainee, etc. A full black line ellipse designates the SoI, the IO is designated by a dotted line ellipse, and the non-IO is designated by a dush-point line ellipse.

For example, image 6a demonstrates a subject, e.g., trainee, while exercising. The SoI has objects in the background, e.g., non-IO, that he does not interact with while interacting with the towel, e.g., IO.

For example, image 6b demonstrates an SoI, e.g., a football player (soccer), that interacts with the ball (IO).

For example, image 6c demonstrates SoI, e.g., a basketball player interacting with a ball, e.g., IO. However, the basketball player, e.g., the SoI, may not interact with the plurality of cons, e.g., non-IOs.

For example, image 6d demonstrates an SoI, e.g., a golf player, interacting with a golf club and the ball, e.g., IOs.

In some demonstrative embodiment, the SoI, may include one or more subjects and may be dynamically allocated based on the context of the scene. For example, the SoI may include a player interacting with a ball, a player interacting with another player, a team of players, and the like.

In some demonstrative embodiments, the algorithm of detecting objects in the scene may start by the user, e.g., trainer, that manually label detected object in the scene. For example, the scene, e.g., each scene, may be recognized by a label from a set of the recognized labels, e.g., player number 1, 2 . . . , interacting object 1, 2 . . . , the user may elect the subject and object of interest and the like.

In some demonstrative embodiments, the algorithm may use prior knowledge such as, for example, closes proximity, type of shirt of the player, and the like. For example, if the prior knowledge may be related to the SoI, for example, his/her proximity, type of color, and body dimensions, it can be used to choose the SoI and related OIs. For example, the SoI may be detected by proximity, and/or type of color, and/or body dimensions and/or the like. It should be understood that other features of the SoI may be selected.

In some demonstrative embodiments, the algorithm may use description syntax and machine learning recognition algorithms. For example, the user may write descriptive text on analyzing the trainee performance, e.g., the SoI.

In some demonstrative embodiments, the machine learning may include a machine learning-based text interpreter and a deep learning algorithm such as, for example, Long Short-Term Memory (LSTM), attention networks, or the like.

In some demonstrative embodiments, the algorithm may generate a list of SoI, e.g., trainee, players, based on training data set, and the trainee history with expert knowledge labeling. It should be understood that for each type of sport, there may be different expert labels and SoI.

For example, the user may select the SoI from a lower rank of the training data set, and/or the machine-learning AI-based algorithm may select the SoI. For example, the SoI may be selected based on the SoI history and set of features, such as, for example, proportions, type of movement, and the like.

In some demonstrative embodiments, the algorithm may be configured to use historical trained data on the selected SoI and the type of activity. For example, the algorithm may use previously trained data that classify the SoI identity e.g., proportions, type of movement, and the like.

Reference is now made to FIG. 7, which includes an image 710 that demonstrates SoI skeleton points of measurements and an image 720 that demonstrate a basketball player interacting with a ball, according to some demonstrative embodiments. For example, image 730 shows skeleton features. The skeleton features may include jump height, launch angle, body tilt, and the like.

For example, image 720 shows the skeleton features as described at box 730 and the basketball features, e.g., IO features. Text box 740 shows the basketball features, g., IO features, that may include a ball radius, a ball velocity at shooting, a ball spin at shooting, and the like.

In some demonstrative embodiments, raw data may be used to produce the SoI features and the IO features that can be used to analysis the SoI performance at the training. The SoI features and the IO features may be calculated to the subject of interest, e.g., basketball player, and the interacting objects, e.g., cones and basketball.

For example, the SoI features and the IO features may be integrated with other systems and sensors to improving the accuracy of the measurements. The accuracy may be improved by aggregating data of the systems and sensors to the machine learning.

For example, a calibration process may be used, either at the start of the operation and/or continually. The calibration process may use one or more sensors, e.g., a cellphone camera and/or other cameras.

In some demonstrative embodiments, an algorithm may be used to monitor and analyze one or more features of SoI. For example, the algorithm may monitor the skeleton 710 of the SoI. For example, the feature may include skeleton key points over time, e.g., the distance between the legs. Other features such as, for example, colors, edges, also can be applied and used from the main skeletal-spatial features. Spatiotemporal features may also be extracted.

For example, the SoI features and the IO features may include the skeleton 710, machine learning-based features, analytical features, angles, temporal features, spatiotemporal features such as, for example, angular velocity, orientation, speed, the distance between legs, a hand that dribbles, frequency of repetition, etc.

In some demonstrative embodiments, additional abstract features may be extracted from the sensed data mathematically by using different transformations, such as, for example, entropy, or automatically by neural network and the like.

In some demonstrative embodiments, semantical features may be used when natural language processing (NLP) models aggregate the neural network to decode the subject in the scene, the SoI, and the SoI related to an action.

In some demonstrative embodiments, the IO may include one or more features, although it should be understood that some workouts, training plans, or the like may not include interacting objects.

In some demonstrative embodiments, one or more features of IO may include the size of the object, the spread of the object, orientation in the space of the SoI, velocity and acceleration over time, and/or any other features.

In some demonstrative embodiments, the size-related features may need a size calibration. For example, the size-related features may be obtained in the calibration process using one of the follows: calibrating the size based on prior measure, such as, for example, a ball size, players body dimensions, or the like.

For example, the calibration may be based focus analysis methods, calculated distance from the camera to the object, calibrating using Lidar; calibrating using a plurality of cameras and focus analysis methods to calculate a distance from the camera to the SoI.

In some demonstrative embodiments, the SoI features may be stored in a database. The SoI features may be used for assisting in SoI identification and by a score calculation module.

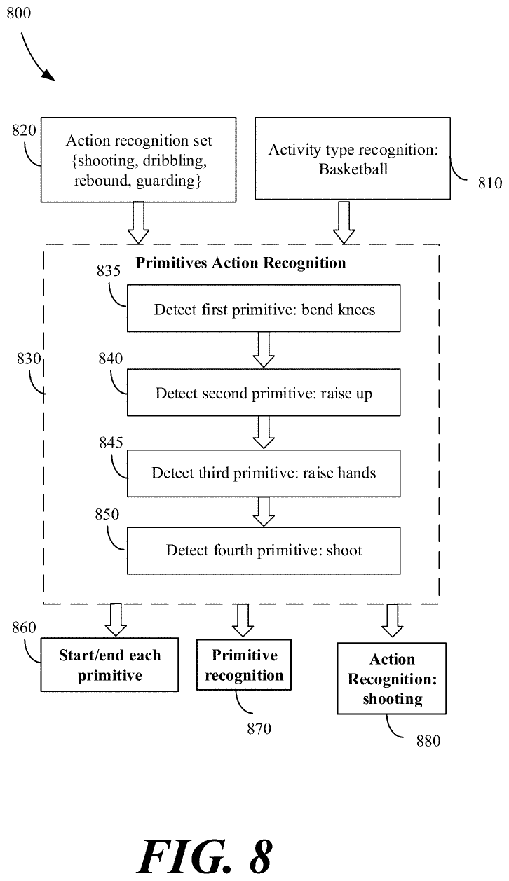

Reference is now made to FIG. 8, which illustrates a flow chart of a method 800 of recognition of primitives of a bio-mechanic activity, according to some demonstrative embodiments.

In some demonstrative embodiments, method 800 may start with activity type recognition (text box 10). The activity type may include, for example, playing basketball, golf, etc., and may be provided by a control unit, e.g., control and configuration unit 270 (FIG. 2.) and/or by automatic detection of the activity.

In some demonstrative embodiments, the automatic detection may be done based on SoI features and IO features and/or directly by raw data.

For example, the derived features or the raw data may be used to classify the activity type and the set of actions.

In some demonstrative embodiments, an action recognition set (text box 820) may be provided for a primitive action recognition task (box 830). The action may be divided into a plurality of sub-actions, called primitive actions, where for each primitive action, the system may provide a score and feedback to the user.

For example, the primitive task may be divided into a plurality of stages based on the SoI, e.g., basketball player. The first stage may be detecting the first primitive, e.g., bend knees (text box 835), the second stage may be detecting the second primitive, e.g., raise up (text box 840), the third stage may be detecting the third primitive, e.g., raise hands (text box 845) and the fourth stage may be detecting the fourth primitive, e.g., shoot (text box 850).

In some demonstrative embodiments, the action primitive recognition task (box 830) may output the start and the end of each primitive 860, the primitive recognition 870, and the action recognition 880.

In some demonstrative embodiments, the action may be recognized: directly from the raw data/features by first recognizing the primitive actions set, then recognizing the start and end of each action primitive, and embedding the recognized action primitive to the action recognition set.

In some demonstrative embodiments, the action primitive may be characterized by one or more abstract groups, e.g., shooting to the basket. The group may include more dedicated actions such as, for example, shooting in a jump-shot and the like.

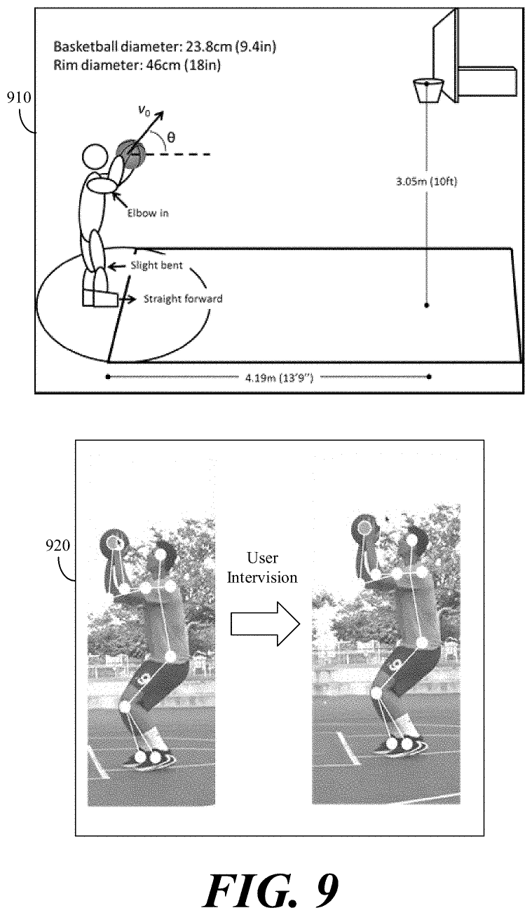

FIG. 9 includes images 910 and 920 that demonstrate skeleton measurements and performance, according to some demonstrative embodiments.

For example, image 910 shows an SoI, e.g., a basketball player shooting a basketball to a basket and measures such as, for example, the basket height, the distance of the player from the basket, a basketball diameter, a ring diameter, angle of throwing the ball and the player skeleton posture while throwing the basketball to the basket.

For example, image 920 shows a skeleton posture of a basketball while throwing the basketball to the basket before a user, e.g., trainer, intervention, and after the user intervention.

In some demonstrative embodiments, an AI utility may be used to generate and performance scores based on a stream of raw data, extracted features per action based on the activity type, and the action subject-related parameters. The scores may be integrated with other systems, with other sensors, and the accuracy may be improved by aggregation of all recommendations to the AI utility and/or to the machine learning trained data.

In some demonstrative embodiments, the performance score may be divided into categories, which may be applied according to user preference. For example, a category, e.g., each category, may be applied separately and/or a combination of any of them.

For example, the main categories may be based on human analytical models, e.g., prior theoretical knowledge, expert labeling by human expert feedback, similarity score to another player, the success of directed goals, such as, for example, passing by dribbling another basketball player, scoring a basket and the like.

In some demonstrative embodiments, the AI utility may be configured with a “REFERENCE BOOK” (FIG. 4), which may include a human analytical prior knowledge, e.g., optimality of the action based on bio-mechanic analytical calculations, for example, the best angle to hold the ball while throwing the ball.

In some demonstrative embodiments, the AI utility may utilize known criteria from models taken from medicine, sport, etc., such as, for example, smooth of movement, ideal movement as learned in existing textbooks, and the like.

In some demonstrative embodiments, the AI utility may be configured with a “REFERENCE COUCH” (FIG. 4), based on expert labeling provided by human expert feedback.

For example, the labeling may be in feature space, such as, for example, skeleton preferred angles when shooting to the basket, and the feedback may be provided manually by user intervention and/or by one or more abstract instructions.

In some demonstrative embodiments, the feedback from a specific expert may be used to form a unique database for this expert by using AI. The feedback may be approximated. The user may select the feedback for each action, e.g., an expert model (FIG. 4).

In some demonstrative embodiments, the AI utility may be configured with a “REFERENCE PLAYER,” which may be based on AI inputs related to the majority of players, and/or a specific player. In some other embodiments, this model may be called a “PLAYER MODEL.” (FIG. 4)

In some demonstrative embodiments, the AI inputs may analyze a plurality of players, a plurality of top-ranked players, and/or a specific player. The score may be related to the similarity to the MODEL players. For example, a comparison between two players may be based on the “PLAYER MODEL.”

In some demonstrative embodiments, the AI utility may be configured with a “GOALS' SUCCESS model” (FIG. 4 text box 450) which may be based on the success of achieving one or more directed goals.

In some demonstrative embodiments, this method is based on success, such as, for example, passing another basketball player, shooting successfully to the basket, etc.

In some demonstrative embodiments, the AI utility 158 (FIG. 1) may be used to calculate the score, and when successful, there will be success labels that will be stored in the database and will enable training the AI.

For example, existing player statistics may be used as the AI reference, and labels an example of such statistic may be presented at https://www.sports-reference.com/blog/2014/10/per-possession-player-stats-added-to-college-basketball/. The success of the action may be achieved if needed by additional sensors.

In some demonstrative embodiments, the performance score may be related to a plurality of parameters, such as, for example, comparison between a desired skeleton movement to an actual skeleton, the quality of interaction with the object of interest, e.g., the angle that a player is holding the ball, time of performance, abstract features like the smoothness of operation and the like.

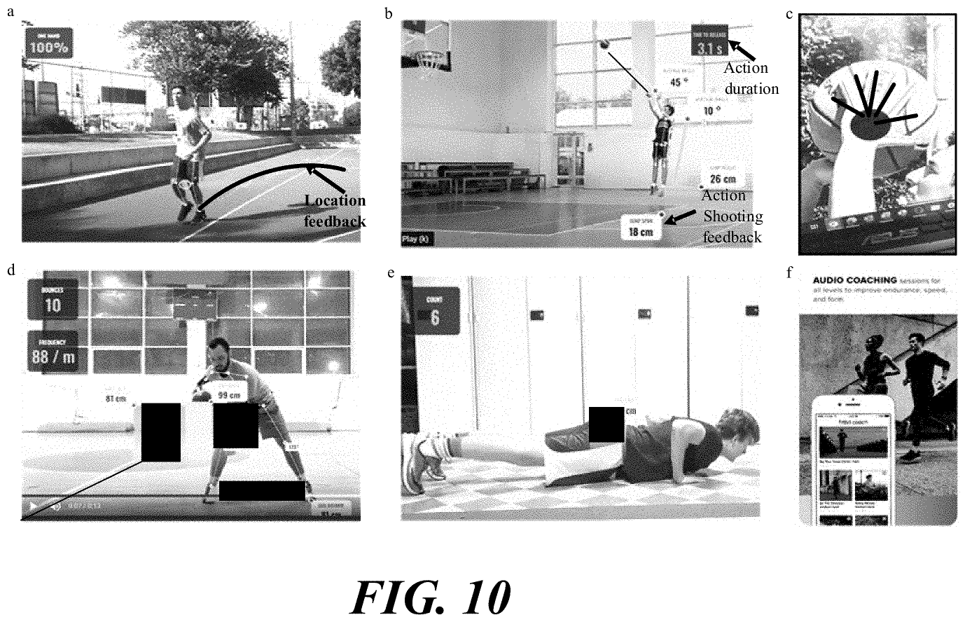

Reference is now made to FIG. 10, which includes images 10a, 10b, 10c, 10d, 10e, and 10f that demonstrate different feedback types to a trainee, according to some demonstrative embodiments.

In some demonstrative embodiments, image 10a shows location tracking while dribbling, image 10b shows feedback on shooting action, including shooting angle, shooting duration, jump height, and span, image 10c shows the type of interaction with the object (ball), such as, for example, an optimal gripping of the object marked by orange colors, image 10d shows color feedback that emphasizes the action feature, image 10e demonstrate count number for repetitive action, and image 10f illustrates how voice commands can instruct the user and give him/her feedback on the quality of the exercise.

In some demonstrative embodiments, the feedback may be used to improve performance and may include a plurality of levels. For example, the feedback may include feedback for a total performance score for the activity, e.g., playing basketball, feedback for a performance score for the action, e.g., shooting, a feedback for a total performance score for the activity, e.g., ball release angle, and the like.

In some demonstrative embodiments, the feedback may be given in “real-time” with a delay for every action and/or a sub-action of the trainee, e.g., player.

In some other demonstrative embodiments, the feedback may be given offline.

In some demonstrative embodiments, the feedback may be given in different ways that may reach the subject, e.g., trainee, attention. For example, the feedback may include visual feedback, auditory and\or tactical feedback with wearable sensors attached to the body and used to send the user, e.g., trainer, feedback on the trainee performance.

In some demonstrative embodiments, the visual feedback may be the proposed skeleton measures and/or proposed parameters verse the one the plates used, which may be integrated into the visual image.

In some demonstrative embodiments, auditory feedback may include commands in real-time to the player, special sounds that mark failure or success in reaching the goal, and the like.

In some demonstrative embodiments, tactile feedback may be attached to the body of the trainee and may signal to the user/player on ways to correct the movements of the trainee.

In some demonstrative embodiments, the feedback system may include a recommendation system, which may be configured to automatically provide statistical recommendations to improve performance

For example, the recommendation system may provide recommendations to improve primitive action, all action, all activity, a team activity, and the like.

In some demonstrative embodiments, the recommendations from the recommendation system may be based on analytical models, expert analysis of the subject statistics that may be used as soft labels, machine learning-based analysis, and the like.

In some demonstrative embodiments, the system may provide an exercise plan to the trainee based on the above-described system, methods, and algorithms.

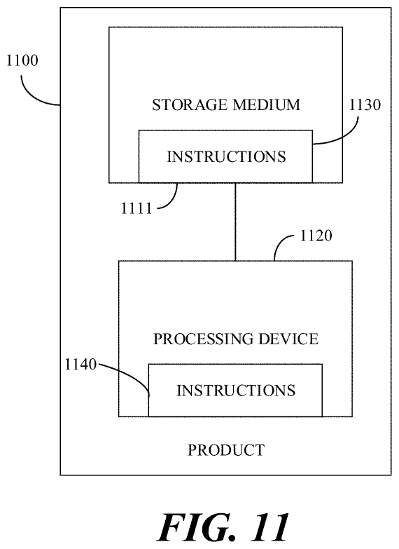

Reference is now made to FIG. 11, which is a schematic illustration of a product of manufacture 1100, according to some demonstrative embodiments. Product 1100 may include one or more tangible computer-readable non-transitory storage media 1110, which may include computer-executable instructions 1130, implemented by processing device 1120, operable to, when executed by at least one computer processor, enable at least one processing device 150 (FIG. 1) to implement one or more program instructions for monitoring, analyzing and providing feedback to a trainee base on the performance as described above with reference to FIGS. 1-10. The phrase “non-transitory machine-readable medium” is directed to include all computer-readable media, with the sole exception being a transitory propagating signal.

In some demonstrative embodiments, product 1100 and/or machine-readable storage medium 1110 may include one or more types of computer-readable storage media capable of storing data, including volatile memory, non-volatile memory, removable or non-removable memory, erasable or non-erasable memory, writeable or re-writeable memory, and the like. For example, machine-readable storage medium 1110 may include any type of memory, such as, for example, RAM, DRAM, ROM, programmable ROM (PROM), erasable programmable ROM (EPROM), electrically erasable programmable ROM (EEPROM), Flash memory, a hard disk drive (HDD), a solid-state disk drive (SDD), fusen drive, and the like. The computer-readable storage media may include any suitable media involved with downloading or transferring a computer program from a remote computer to a requesting computer carried by data signals embodied in a carrier wave or other propagation medium through a communication link, e.g., a modem, radio, or network connection.

In some demonstrative embodiments, processing device 1120 may include logic. The logic may include instructions, data, and/or code, which, if executed by a machine, may cause the machine to perform a method, process, and/or operations as described herein. The machine may include, for example, any suitable processing platform, computing platform, computing device, processing device, a computing system, processing system, computer, processor, or the like, and may be implemented using any suitable combination of hardware, software, firmware, and the like.

In some demonstrative embodiments, processing device 1120 may include or may be implemented as software, firmware, a software module, an application, a program, a subroutine, instructions, an instruction set, computing code, words, values, symbols, and the like. Instructions 1140 may include any suitable types of code, such as source code, compiled code, interpreted code, executable code, static code, dynamic code, and the like. Instructions may be implemented according to a predefined computer language, manner or syntax, for instructing a processor to perform a specific function. The instructions may be implemented using any suitable high-level, low-level, object-oriented, visual, compiled and/or interpreted programming languages, such as C, C++, C#, Java, Python, BASIC, Matlab, assembly language, machine code, and the like.

It is to be understood that the system and/or the method for monitoring, analyzing, and providing feedback to a trainee based on the trainee performance is described hereinabove by way of example only. Other embodiments may be implemented base on the detailed description and the claims that followed.

It is to be understood that like numerals in the drawings represent like elements through the several figures and that not all components and/or steps described and illustrated with reference to the figures are required for all embodiments or arrangements.

It should also be understood that the embodiments, implementations, and/or arrangements of the systems and methods disclosed herein can be incorporated as a software algorithm, application, program, module, or code residing in hardware, firmware and/or on a computer useable medium (including software modules and browser plug-ins) that can be executed in a processor of a computer system or a computing device to configure the processor and/or other elements to perform the functions and/or operations described herein.

It should be appreciated that according to at least one embodiment, one or more computer programs, modules, and/or applications that, when executed, perform methods of the present invention need not reside on a single computer or processor but can be distributed in a modular fashion amongst a number of different computers or processors to implement various aspects of the systems and methods disclosed herein.

Thus, illustrative embodiments and arrangements of the present systems and methods provide a computer-implemented method, computer system, and computer program product for processing code(s). The flowchart and block diagrams in the Figures illustrate the architecture, functionality, and operation of possible implementations of systems, methods, and computer program products according to various embodiments and arrangements. In this regard, each block in the flowchart or block diagrams can represent a module, segment, or portion of code, which comprises one or more executable instructions for implementing the specified logical function(s).

It should also be noted that, in some alternative implementations, the functions noted in the block can occur out of order noted in the figures. For example, two blocks shown in succession may be executed substantially concurrently, or the blocks can sometimes be executed in the reverse order, depending upon the functionality involved. It will also be noted that each block of the block diagrams and/or flowchart illustration, and combinations of blocks in the block diagrams and/or flowchart illustration, can be implemented by particular purpose hardware-based systems that perform the specified functions or acts or combinations of specialized purpose hardware and computer instructions.

The terminology used herein is to describe particular embodiments only and is not intended to be limiting the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Also, the phraseology and terminology used herein are for the purpose of description and should not be regarded as limiting. The use of “including,” “comprising,” or “having,” “containing,” “involving,” and variations thereof herein is meant to encompass the items listed thereafter and equivalents thereof as well as additional items.

### EXAMPLES

The following examples pertain to further embodiments.

Example 1 includes a system for monitoring bio-mechanic activity, comprising a user device comprises processing circuitry and one or more sensors, wherein the processing circuitry configured to: generate a training plan for a subject of interest (SoI) based on an artificial intelligence (AI) model and historical performances of other Sols of the same field of training as the SoI; set one or more goals to the SoI according to the training plan; monitor by the one or more sensors SoI performances toward the one or more goals according to the training plan; extract from monitored data at least one of: one or more features of the SoI, one or more features of interacting objects (IO)s, one or more features of non-interacting objects and provide one or more measurement results related to time and space of the one or more SoI features; and update the AI model based on SoI performance data and machine learning data.

Example 2 includes the subject matter of Example 1, and optionally, wherein the processing circuitry configured to: detect in sensed data received from the one or more sensors, first data related to the SoI, second data related to the one or more interacting IOs, third data related to the non-interacting object and fourth data related to a scene, wherein the detection is done based on at least one method of one or more AI methods and trained data generated by a machine learning process; extract from the first data the one or more features of the SoI and provide the one or more measurement results related to time and space of the one or more SoI features; extract from the second data the one or more features of the IOs and provide one or measurements results related to time and space of the one or more IO features; based on the machine learning trained data, generate an activity type for the SoI, analyze the first data for bio-mechanic activity, and compute a performance score of the SoI by using the at least one method of the one or more AI methods; and provide a performance feedback on the SoI performance by using one or more types of the performance feedback.

Example 3 includes the subject matter of Example 1, and optionally, wherein the one or more sensors comprise one or more cameras and are configured to monitor an interaction of the SoI with the one or more IOs in a scene.

Example 4 includes the subject matter of Example 1, and optionally, wherein the first data comprising bio-mechanic activity data.

Example 5 includes the subject matter of Example 1, and optionally, wherein the machine learning is configured to train data by comparing performance data of one or more players with the SoI performance based on machine learning trained data.

Example 6 includes the subject matter of Example 1, and optionally, wherein the processing circuitry is configured to train data based on one or more analytical models.

Example 7 includes the subject matter of Example 1, and optionally, wherein the machine learning is configured to train data based on one or more trainer preferences.

Example 8 includes the subject matter of Example 1, and optionally, wherein the one or more features of the SoI comprise at least one of: a skeleton, one or more body-related features, wherein the one or more body-related features include at least one of: a distance between legs, a velocity of body parts, and an angle between the body parts.

Example 9 includes the subject matter of Example 1, and optionally, wherein the one or more features of the IOs comprise at least one of: a size of an IO, a velocity of the IO, an orientation of the IO and a location in the space of the IO.

Example 10 includes the subject matter of Example 1, and optionally, wherein the processing circuitry configured to: extract from the first data and the second data one or more features of interacting between the SoI and the IO, wherein the one or more features of interacting between the SoI and the IO comprise at least one of a frequency of repetitive action, a location, one or more estimated forces, and one or more angles of the IO in relation to the SoI.

Example 11 includes the subject matter of Example 2, and optionally, wherein the at least one of the AI methods is configured to recognize an action, wherein the action is a predefined activity of the SoI, which includes a goal-oriented, a start time, and an end time.

Example 12 includes the subject matter of Example 11, and optionally, wherein the action is classified according to one or more features and wherein the one or more features include a list of primitive actions.

Example 13 includes the subject matter of Example 1, and optionally, wherein the SoI performance score is determined based on one or more categories, wherein the one or more categories comprise a reference book, a reference couch, a player model, and a success level of achieving a goal.

Example 14 includes the subject matter of Example 13, and optionally, wherein the reference book is generated based on human analytical models and, wherein the AI method is configured to utilize known criteria to provide the performance score.

Example 15 includes the subject matter of Example 13, and optionally, wherein the reference couch is generated based on an expert labeling by a human expert feedback, wherein the labeling comprises a skeleton preferred angle when shooting to the basket, feedback provided by the manual user intervention, and by one or more abstract instructions.

Example 16 includes the subject matter of Example 15, and optionally, wherein the human expert feedback from a specific expert is used to generate a unique expert model by using the AI model.

Example 17 includes the subject matter of Example 13, and optionally, wherein the player model is generated based on a similarity score of a player to another player, which is done with AI inputs that analyze data related to at least one of a plurality of players, a plurality of top-ranked players, a specific player, and configured to provide a player score that related on the similarity to the players' model.

Example 18 includes the subject matter of Example 17, and optionally, wherein a success level of achieving a goal is based on the success of achieving directed goals and the player score is calculated by the AI.

Example 19 includes the subject matter of Example 2, and optionally, wherein the performance feedback is provided whether the user device is offline or online and comprises a real-time feedback based on the monitoring of the SoI and evaluation of the SoI performance.

Example 20 includes the subject matter of Example 1, and optionally, wherein the performance feedback comprises: an at least one of: a visual color feedback, a voice instruction feedback, and an electrical stimulation feedback.

Example 21 includes a system configured to classify a performance of a bio-mechanic activity of a subject for interest (SoI) while interacting with one or more interacting object (IO), wherein the system comprising: a sensing unit configured to monitor the interaction of the SoI with the IO, a processing unit configured to analyze the interaction based on at least one method of one or more artificial intelligent (AI) methods and trained data of a machine learning; a feedback unit is configured to provide a performance feedback base on a performance of the SoI and interact with a user.

Example 22 includes the subject matter of Example 21, and optionally, wherein the processing unit is configured to detect the SoI and the IO based on the one or more AI methods.

Example 23 includes the subject matter of Example 21, and optionally, wherein the processing unit is configured to detect a non-interacting object based on the one or more AI methods.

Example 24 includes the subject matter of Example 21, and optionally, wherein the at least one method of the one or more AI methods is configured to extract one or more features of The SoI and the IO.

Example 25 includes the subject matter of Example 21, and optionally, wherein the at least one method of the one or more AI methods is configured to generate a recognition activity type of the SoI.

Example 26 includes the subject matter of Example 21, and optionally, wherein the at least one method of the one or more AI methods is configured to detect one or more action phases of the SoI.

Example 27 includes the subject matter of Example 21, and optionally, wherein the at least one method of the one or more AI methods is configured to: estimate a performance score of the SoI and provide the performance feedback to the user.

Example 28 includes the subject matter of Example 21, and optionally, wherein the one or more AI methods comprise an algorithm to detect one or more Sols at a scene of activity.

Example 29 includes the subject matter of Example 21, and optionally, wherein the method is based on data received from one or more databases and configured to use machine learning to train the data and to provide trained data.

Example 30 includes the subject matter of Example 21, and optionally, wherein at least one method of the one or more AI methods is configured to detect the SoI based on pre-trained data and a prior knowledge that configured to integrated with content using one or more natural language processing (NLP) methods

Example 31 includes the subject matter of Example 21, and optionally, wherein the detection of the SoI and the at least one of the IOs is done in one or more parallel processes.

Example 32 includes the subject matter of Example 1, and optionally, wherein the one or more features of the SoI comprise at least one of: a skeleton, one or more body-related features, wherein the one or more body-related features include at least one of: a distance between legs, a velocity of body parts, and an angle between the body parts.

Example 33 includes the subject matter of Example 21, and optionally, wherein the one or more features of the IO comprise at least one of: a size of the IO, a velocity of the IO, an orientation of the IO and a location in a space of the IO.

Example 34 includes the subject matter of Example 21, and optionally, wherein the one or more features of interacting between the SoI and the IO comprise at least one of a frequency of repetitive action, a location, one or more estimated forces, and one or more angles of the IO in relation to the SoI.

Example 35 includes the subject matter of Example 21, and optionally, wherein the at least one method of the one or more AI methods is configured to recognize an action recognition, wherein the action is a predefined SoI activity which includes a goal-oriented, a start time, and an end time.

Example 36 includes the subject matter of Example 35, and optionally, wherein the one or more features of the action include a list of primitive actions.

Example 37 includes the subject matter of Example 35, and optionally, wherein the action comprises a throwing a ball action which composed from bending knees, pushing the ball up, and releasing the ball.

Example 38 includes the subject matter of Example 36, and optionally, wherein a primitive action is recognized by at least one of the SoI and the Jo features.

Example 39 includes the subject matter of Example 37, and optionally, wherein the performance scores are performed automatically by at least one of the machine learning, an expert training, and analytically.

Example 40 includes the subject matter of Example 37, and optionally, wherein the performance score is done based on one or more categories, wherein the one or more categories comprise a reference book, a reference couch, a player model, and a success level of achieving a goal.

Example 41 includes the subject matter of Example 40, and optionally, wherein the reference book is generated based on human analytical models and the at least one method of the one or more AI methods is configured to utilize known criteria from models taken from medicine and sport to provide the performance score.

Example 42 includes the subject matter of Example 40, and optionally, wherein the reference couch is generated based on an expert labeling by the human expert feedback, wherein the labeling comprises: a skeleton preferred angle when shooting to the basket, feedback provided by the manual user intervention, and by one or more abstract instructions.

Example 43 includes the subject matter of Example 42, and optionally, wherein the feedback from an expert is used to generate a unique expert model by using the AI.

Example 44 includes the subject matter of Example 40, and optionally, wherein the player model is generated based on a similarity score to another player, which is done with AI inputs that analyze data of: at least one of a plurality of players, a plurality of top-ranked players and a specific player, and configured to provide a score that related on the similarity to the player model.

Example 45 includes the subject matter of Example 40, and optionally, wherein the success level of achieving a goal is based on the success of directed goals, and the score is calculated by the AI.

Example 46 includes the subject matter of Example 45, and optionally, wherein when the goal is successful, the AI is configured to generate a success label to be stored at a database as data for enabling training the AI.

Example 47 includes the subject matter of Example 21, and optionally, wherein the feedback unit is configured to provide a real-time feedback base on monitoring the performance of the SoI, wherein the feedback comprises evaluation of the SoI performance.

Example 48 includes the subject matter of Example 21, and optionally, wherein the feedback unit is configured to provide the feedback on at least one of a primitive action, quality of primitive action, a total action, statistics for similar actions, and statistical aggregation from similar actions.

Example 49 includes the subject matter of Example 21, and optionally, wherein the feedback comprises: an at least one of visual colors, of reference vs. a performed way, voice instructions, and an electrical stimulation feedback.

Example 50 includes the subject matter of Example 21, and optionally, wherein the one or more AI methods comprise a recommendation method, wherein the recommended method is configured to provide a statistical recommendation to improve performance.

Example 51 includes the subject matter of Example 50, and optionally, wherein the recommendation method includes one or more suggestions for: a primitive action, an all-action, an all activity, and a team activity.

Example 52 includes the subject matter of Example 50 and optionally, wherein the recommendation method is based on at least one of analytical models, expert analysis of the subject statistics to be used as soft labels, machine learning-based analysis

Example 53 includes the subject matter of Example 50, and optionally, wherein the recommendation method is configured to provide a short-term training plan and a long-term training plan.

Example 54 includes the subject matter of Example 21, and optionally, wherein the system comprises an interaction unit configured to interact with the user by text commands and vocal commands.

Example 55 includes the subject matter of Example 21 and optionally, wherein the system is configured to estimate the distances of the subject of interest and interacting object by calculating distances with a single video camera and by constructing a 3-D skeleton and distances based on one or more video resources.

Example 56 includes the subject matter of Example 21 and optionally, wherein the system is configured to separate between skeletons and objects in a multi-subject scene and construct 3-D subject skeleton location in a global coordinate to solve ambiguity based on one or more streams of data.

Example 57 includes the subject matter of Example 21 and optionally, wherein the system is configured to characterize the type of interaction with the IO and provide ways of interaction, according to the performance score.

Example 58 includes an apparatus for monitoring bio-mechanic activity, comprising a processor circuitry and one or more sensors, wherein the processor circuitry configured to: generate a training plan for a subject of interest (SoI) based on an artificial intelligence (AI) model and historical performances of other Sols of the same field the SoI; set one or more goals to the SoI according to the training plan; monitor by the one or more sensors SoI performances toward the one or more goals according to the training plan; extract from monitored data at least one of: one or more SoI features, one or more interacting objects (IO)s features, one or more non-interacting objects features and provide one or more measurement results related to time and space of the one or more SoI features; and update the AI model based on an SoI performance score and machine learning data.

Example 59 includes the subject matter of Example 58 and optionally, wherein the processing circuitry is configured to: detect in sensed data received from the one or more sensors, first data related to the SoI, second data related to the one or more interacting IOs, third data related to the non-interacting object and fourth data related to a scene, wherein the detection is done based on an at least one method of one or more AI methods and trained data generated by a machine learning process; extract from the first data the one or more SoI features and provide the one or more measurement results related to time and space of the one or more SoI features; extract from the second data the one or more IO features and provide one or measurements results related to time and space of the one or more IO features; based on the machine learning trained data, generate an activity type for the SoI, analyze the first data to bio-mechanic activity, and compute a performance score of the SoI by using the at least one method of the one or more AI methods; and provide a feedback on the SoI performance by using one or more types of performance feedback.

Example 60 includes the subject matter of Example 58 and optionally, wherein the one or more sensors comprise one or more cameras and are configured to monitor an interaction of the SoI with the one or more IOs in a scene.

Example 61 includes the subject matter of Example 58 and optionally, wherein the first data comprising bio-mechanic activity data.

Example 62 includes the subject matter of Example 58 and optionally, wherein the machine learning is configured to train data by comparing performance data of one or more players with the SoI performance based on the machine learning trained data.

Example 63 includes the subject matter of Example 58 and optionally, wherein the processing circuitry is configured to train data based on one or more analytical models.

Example 64 includes the subject matter of Example 58 and optionally, wherein the machine learning is configured to train data based on one or more trainer preferences.

Example 65 includes the subject matter of Example 58 and optionally, wherein the one or more features of the SoI comprise at least one of: a skeleton, one or more body-related features, wherein the one or more body-related features include at least one of a distance between legs, a velocity of body parts, and an angle between the body parts.

Example 66 includes the subject matter of Example 58 and optionally, wherein the one or more features of the IOs comprise at least one of: a size of an IO, a velocity of the IO, an orientation of the IO and a location in the space of the IO.

Example 67 includes the subject matter of Example 66 and optionally, wherein the one or more features of interacting between the SoI and the IO comprise at least one of a frequency of repetitive action, a location, one or more estimated forces, and one or more angles of the IO in relation to the SoI.

Example 68 includes the subject matter of Example 59 and optionally, wherein at least one of the AI methods is configured to recognize an action, wherein the action is a predefined activity subject which includes a goal-oriented, a start time, and an end time.

Example 69 includes the subject matter of Example 68 and optionally, wherein the one or more features of the action include a list of primitive actions.

Example 70 includes the subject matter of Example 58 and optionally, wherein the SoI performance score is determined based on one or more categories, wherein the one or more categories comprise a reference book, a reference couch, a player model, and a success level of achieving a goal.

Example 71 includes the subject matter of Example 70 and optionally, wherein the reference book is generated based on human analytical models and wherein the AI method is configured to utilize known criteria to provide the performance score.

Example 71 includes the subject matter of Example 70 and optionally, wherein the reference couch is generated based on expert labeling by a human expert feedback, wherein the labeling comprises a skeleton preferred angle when shooting to the basket, feedback provided by the manual user intervention, and by one or more abstract instructions.

Example 72 includes the subject matter of Example 71 and optionally, wherein the human expert feedback from a specific expert is used to generate a unique expert model by using the AI model.

Example 73 includes the subject matter of Example 70 and optionally, wherein the player model is generated based on a similarity of a score of a player to another player, which is done with AI inputs that analyze at least one of a plurality of players, a plurality of top-ranked players, a specific player, and configured to provide a score that related on the similarity to the player model.

Example 74 includes the subject matter of Example 70 and optionally, wherein the success level of achieving a goal is based on the success of directed goals and the score calculated by the AI.

Example 75 includes the subject matter of Example 59 and optionally, wherein the feedback comprises at least one of an offline feedback and a real-time feedback based on the monitoring the SoI and evaluation of the SoI performance.

Example 76 includes the subject matter of Example 58 and optionally, wherein the feedback comprises: an at least one of visual colors feedback, reference to other player performance versus a performed way of the player, voice instructions feedback, and an electrical stimulation feedback.

Example 78 includes a product comprising one or more tangible computer-readable non-transitory storage media comprising program instructions for monitoring an interaction of a subject of interest (SoI) with one or more interacting objects (IO)s, wherein execution of the program instructions by one or more processors comprising: generating a training plan for the SoI based on an artificial intelligence (AI) model and historical performances of other Sols of the same field the SoI; setting one or more goals to the SoI according to the training plan; monitoring, by the one or more sensors, SoI performances toward the one or more goals according to the training plan; extracting from monitored data at least one of: one or more SoI features, one or more IOs features, one or more non-interacting objects features and provide one or more measurement results related to time and space of the one or more SoI features; and updating the AI model based on SoI performance score and machine learning data.

Example 79 includes the subject matter of Example 78 and optionally, wherein the execution of the program instructions by one or more processors comprising: detecting in sensed data received from the one or more sensors first data related to the SoI, second data related to the one or more IOs, third data related to the non-interacting object and fourth data related to a scene, wherein the detection is done based on at least one method of one or more AI methods and trained data generated by a machine learning process; extracting from the first data one or more SoI features and provide one or more measurement results related to time and space of the one or more SoI features; extracting from the second data one or more IO features and provide one or measurements results related to time and space of the one or more IO features; based on the machine learning trained data, generating an activity type for the SoI, analyze the first data to bio-mechanic activity, and compute a performance score of the SoI by using the at least one method of the one or more AI methods; and providing a performance feedback on the SoI performance by using one or more types of the performance feedback.

Example 80 includes the subject matter of Example 78 and optionally, wherein execution of the program instructions by one or more processors comprising: training data by comparing performance data of one or more players with the SoI performance based on machine learning trained data.

Example 81 includes the subject matter of Example 78 and optionally, wherein execution of the program instructions by one or more processors comprising: training data based on one or more analytical models.

Example 82 includes the subject matter of Example 78 and optionally, wherein execution of the program instructions by one or more processors comprising: training data based on one or more trainer preferences.

Example 83 includes the subject matter of Example 78 and optionally, wherein execution of the program instructions by one or more processors comprising: determining the SoI performance score based on one or more categories, wherein the one or more categories comprise a reference book, a reference couch, a player model, and a success level of achieving a goal.

Example 84 includes the subject matter of Example 83 and optionally, wherein execution of the program instructions by one or more processors comprising: generating the reference book based on human analytical models and wherein the AI method is configured to utilize known criteria to provide the performance score.

Example 85 includes the subject matter of Example 83 and optionally, wherein execution of the program instructions by one or more processors comprising: generating the reference couch based on expert labeling by a human expert feedback, wherein the labeling comprises a skeleton preferred angle when shooting to the basket, feedback provided by the manual user intervention, and by one or more abstract instructions.

Example 86 includes the subject matter of Example 83 and optionally, wherein execution of the program instructions by one or more processors comprising: generating a unique expert model by using the AI model based on the human expert feedback from a specific expert.

Example 87 includes the subject matter of Example 83 and optionally, wherein execution of the program instructions by one or more processors comprising: generating the player model is generated based on a similarity of a score of a player to another player received from the AI that analyzes at least one of a plurality of players, a plurality of top-ranked players, a specific player, and configured to provide a score that related on the similarity to the player model.

Example 88 includes the subject matter of Example 78 and optionally, wherein execution of the program instructions by one or more processors comprising: providing at least one of an offline feedback or a real-time feedback based on the monitoring the SoI and evaluation of the SoI performance, wherein the feedback comprises: an at least one of visual colors, of reference vs. a performed way, voice instructions, and an electrical stimulation feedback.

Example 89 includes a method for monitoring bio-mechanic activity by processing circuitry of a user device comprises a and one or more sensors, wherein the method comprising: generating a training plan for a subject of interest (SoI) based on an artificial intelligence (AI) model and the historical performance of other SoIs of the same field the SoI; setting one or more goals to the SoI according to the training plan; monitoring SoI performances toward the one or more goals by the one or more sensors according to the training plan; extracting from monitored data at least one of: one or more SoI features, one or more interacting objects (IO)s features, one or more non-interacting objects features and provide one or more measurement results related to time and space of the one or more SoI features; and updating the AI model based on SoI performance score and machine learning data.

Example 90 includes the subject matter of Example 89 and optionally comprising: detecting in sensed data received from the one or more sensors first data related to the SoI, second data related to the one or more IOs, third data related to the non-interacting object and fourth data related to a scene, wherein the detection is done based on at least one method of one or more AI methods and trained data generated by a machine learning process; extracting from the first data one or more SoI features and provide one or more measurement results related to time and space of the one or more SoI features; extracting from the second data one or more IO features and provide one or measurement results related to time and space of the one or more IO features; based on the machine learning trained data, generating an activity type for the SoI, analyze the first data for bio-mechanic activity, and compute a performance score of the SoI by using the at least one method of the one or more AI methods; and providing feedback on the SoI performance by using one or more types of performance feedback.

Example 91 includes the subject matter of Example 89 and optionally comprising: training data by comparing performance data of one or more players with the performance data of the SoI.

Example 92 includes the subject matter of Example 89 and optionally comprising: training data based on one or more analytical models.

Example 93 includes the subject matter of Example 89 and optionally comprising: training data based on one or more trainer preferences.

Example 94 includes the subject matter of Example 89 and optionally comprising: determining the SoI performance score based on one or more categories, wherein the one or more categories comprise a reference book model, a reference couch model, a player model, and a success level of achieving a goal measure.

Example 95 includes the subject matter of Example 94 and optionally comprising: generating the reference book model based on human analytical models and, wherein the AI method is configured to utilize known criteria to provide the performance score.

Example 96 includes the subject matter of Example 94 and optionally comprising: generating the reference couch model based on expert labeling by a human expert feedback, wherein the expert labeling comprises a skeleton preferred angle when shooting to the basket, feedback provided by the manual user intervention, and by one or more abstract instructions.

Example 97 includes the subject matter of Example 94 and optionally comprising: generating an expert model by using the AI model based on the human expert feedback from an expert.

Example 98 includes the subject matter of Example 94 and optionally comprising: generating the player model based on a similarity of a score of a player to another player received from the AI that analyzes at least one of a plurality of players, a plurality of top-ranked players, a specific player, and configured to provide a score that related on the similarity to the player model.

Example 99 includes the subject matter of Example 89 and optionally comprising: providing at least one of an offline feedback or a real-time feedback based on the monitoring of the SoI and an evaluation of the SoI performance, wherein the feedback comprises: at least one of visual colors feedback, voice instructions feedback, and an electrical stimulation feedback.

The subject matter described above is provided by way of illustration only and should not be construed as limiting. Various modifications and changes can be made to the subject matter described herein without following the example embodiments and applications illustrated and described and without departing from the true spirit and scope of the present invention, which is set forth in the following claims.

What is claimed is:

1. A system for monitoring bio-mechanic activity, comprising a user device comprises processing circuitry and one or more sensors, wherein the processing circuitry configured to:
generate a training plan for a subject of interest (SoI) based on an artificial intelligence (AI) model and a historical performance of other Sols of the same field of training as the SoI;
set one or more goals to the SoI according to the training plan;
monitor by the one or more sensors SoI performances toward the one or more goals according to the training plan;
extract from monitored data at least one of: one or more features of the SoI, one or more features of interacting objects (IO)s, one or more features of non-interacting objects and provide one or more measurement results related to time and space of the one or more SoI features; and
update the AI model based on SoI performance data and machine learning data.

2. The system of claim 1, wherein the processing circuitry is configured to:
detect in sensed data received from the one or more sensors, first data related to the SoI, second data related to the one or more IOs, third data related to the non-interacting object and fourth data related to a scene, wherein the detection is done based on at least one method of one or more AI methods and trained data generated by a machine learning process;
extract from the first data the one or more features of the SoI and provide the one or more measurement results related to time and space of the one or more SoI features;
extract from the second data the one or more features of the IOs and provide one or measurements results related to time and space of the one or more IO features;
based on the machine learning trained data, generate an activity type for the SoI, analyze the first data for bio-mechanic activity, and compute a performance score of the SoI by using the at least one method of the one or more AI methods; and
provide a feedback on the SoI performance by using one or more types of the feedback.

3. The system of claim 1, wherein the one or more sensors comprise one or more cameras and are configured to monitor an interaction of the SoI with the one or more IOs in a scene.

4. The system of claim 1, wherein the first data comprising bio-mechanic activity data.

5. The system of claim 1, wherein the machine learning is configured to train data by comparing performance data of one or more players with the SoI performance based on machine learning trained data.

6. The system of claim 1, wherein the processing circuitry is configured to train data based on one or more analytical models.

7. The system of claim 1, wherein the machine learning is configured to train data based on one or more trainer preferences.

8. The system of claim 1, wherein the one or more features of the SoI comprise at least one of: a skeleton posture of the SoI, one or more body-related features, wherein the one or more body-related features include at least one of: a distance between legs, a velocity of body parts, and an angle between the body parts.

9. The system of claim 1, wherein the one or more features of the IOs comprise at least one of:
a size of an IO, a velocity of the IO, an orientation of the IO and a location in the space of the IO.

10. The system of claim 1, wherein the processing circuitry configured to:
extract from the first data and the second data one or more features of interacting between the SoI and the IO, wherein the one or more features of interacting between the SoI and the IO comprise at least one of a frequency of repetitive action, a location, one or more estimated forces, and one or more angles of the IO in relation to the SoI.

11. The system of claim 2, wherein the at least one of the AI methods is configured to recognize an action, wherein the action is a predefined activity of the SoI which includes a goal-oriented, a start time, and an end time.

12. The system of claim 11, wherein the action is classified by one or more features, wherein the one or more features include a list of primitive actions.

13. The system of claim 1, wherein the SoI performance score is determined based on one or more categories, wherein the one or more categories comprise a reference book, a reference couch, a player model, and a success level of achieving a goal.

14. The system of claim 13, wherein the reference book is generated based on human analytical models and, wherein the AI method is configured to utilize known criteria to provide the performance score.

15. The system of claim 13, wherein the reference couch is generated based on an expert labeling by a human expert feedback, wherein the labeling comprises a skeleton preferred angle when shooting to the basket, feedback provided by the manual user intervention, and by one or more abstract instructions.

16. The system of claim 15, wherein the human expert feedback from a specific expert is used to generate a unique expert model by using the AI model.

17. The system of claim 13, wherein the player model is generated based on a similarity score of a player to another player, which is done with AI inputs that analyze data related to at least one of a plurality of players, a plurality of top-ranked players, a specific player, and configured to provide a player score that related on the similarity to the player model.

18. The system of claim 17, wherein a success level of achieving a goal is based on the success of achieving directed goals and the player score is calculated by the AI.

19. The system of claim 2, wherein the performance feedback is provided whether the user device is offline or online and comprises a real-time feedback based on the monitoring of the SoI and evaluation of the SoI performance.

20. The system of claim 1, wherein the performance feedback comprises:
an at least one of: a visual color feedback, a voice instruction feedback, and an electrical stimulation feedback.
